(19) United States
(12) Patent Application Publication
(10) Pub. No.: US 2004/0156994 A1
(43) Pub. Date: Aug. 12, 2004

(54) Use of aqueous dispersions of addition polymer and finely divided inorganic solid to prime mineral substrates

(75) Inventors: Harm Wiese, Heidelberg (DE); Alexander Centner, Neustadt (DE); Stefan Kirsch, Heidesheim (DE); Marco Schmidt, Speyer (DE); Ines Pietsch, Speyer (DE); Matthias Laubender, Schifferstadt (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/739,001

(22) Filed: Dec. 19, 2003

(30) Foreign Application Priority Data
Dec. 20, 2002 (DE) 10260337.5

(51) Int. Cl. B05D 3/02

(52) U.S. Cl. 427/372.2

(57) ABSTRACT

Aqueous dispersions of composite particles composed of addition polymer and finely divided inorganic solid and obtainable by free-radical emulsion polymerization on a mixture of ethylenically unsaturated monomers including at least one ethylenically unsaturated alkoxysilane monomer in an aqueous medium in the presence of a dispersely distributed, finely divided inorganic solid and at least one dispersant are used to prime mineral substrates.

Aqueous dispersions obtainable by blending an addition polymer obtainable by free-radical emulsion polymerization of a mixture of ethylenically unsaturated monomers including at least one ethylenically unsaturated alkoxy silane monomer in an aqueous medium with a dispersely distributed, finely divided inorganic solid in the presence of at least one dispersant are used to prime glasslike substrates.

The invention relates to the use of aqueous dispersions of addition polymer and finely divided inorganic solid to prime mineral substrates, especially glasslike substrates. The dispersion may comprise particles composed of addition polymer and finely divided inorganic solid or mixtures of addition polymer particles and finely divided inorganic solids.

Aqueous dispersions of composite particles are general knowledge. They are fluid systems whose disperse phase in the aqueous dispersion medium comprises polymer coils composed of a plurality of intertwined polymer chains—called the polymer matrix—and particles composed of finely divided inorganic solid, which are in disperse distribution. The diameter of the composite particles is frequently within the range from 30 nm to 5000 nm.

Like polymer solutions when the solvent is evaporated and aqueous polymer dispersions when the aqueous dispersion medium is evaporated, aqueous dispersions of composite particles have the potential to form modified polymer films containing finely divided inorganic solid, and on account of this potential they are of particular interest as modified binders—for example, for paints or for compositions for coating leather, paper or polymeric films. The composite-particle powders obtainable in principle from aqueous dispersions of composite particles are, furthermore, of interest as additives for plastics, as components for toner formulations or as additives in electrophotographic applications.

JP-A-06-199917 relates to an aqueous dispersion composition which can be used as a coating. In the course of its preparation a mixture of ethylenically unsaturated monomers is mixed with colloidal silica and polymerized in an aqueous dispersion. The ethylenically unsaturated monomers include monomers containing hydroxyl groups. By way of example, 2-hydroxyethyl (meth)acrylate is used as monomer. It is said that the films attach effectively to mineral substrates and exhibit a low vapor permeability and a barrier effect for liquids. The colloidal silica can be used with particle diameters of 4 to 100 nm.

JP-A2-100 36 617 relates to an aqueous emulsion primer composition for cement. The composition is used particularly for applying cement to concrete substrates. The composition comprises a blend of a polymer dispersion with silica particles. First, the polymer dispersion is prepared using vinyltrimethoxysilane monomers. Further monomers used include, for example, styrene, butyl acrylate and methacrylic acid.

The systems known to date are not always sufficiently suitable to prime mineral substrates, especially glasslike substrates.

It is an object of the present invention to provide aqueous dispersions suitable in particular to prime mineral substrates, especially glasslike substrates. The primer coats ought to exhibit very good adhesion to glass and a high strength of the film.

The object is achieved in accordance with the invention by the process for priming mineral substrates involving the step at applying aqueous dispersions of composite particles composed of addition polymer and finely divided inorganic solid and obtainable by free-radical emulsion polymerization of a mixture of ethylenically unsaturated monomers including at least one ethylenically unsaturated alkoxy silane monomer in an aqueous medium in the presence of a dispersely distributed, finely divided inorganic solid and at least one dispersant to mineral substrates.

The mineral substrates are preferably glasslike substrates. The object is further achieved in accordance with the invention by the process for priming mineral substrates involving the step at applying aqueous dispersions obtainable by blending an addition polymer obtainable by free-radical emulsion polymerization of a

mixture of ethylenically unsaturated monomers including at least one ethylenically unsaturated alkoxy silane monomer in an aqueous medium with a dispersely distributed, finely divided inorganic solid in the presence of at least one dispersant to prime glasslike substrates.

The ethylenically unsaturated alkoxysilane monomers are preferably selected from trialkoxysilanes containing vinyl, acryloyloxy or methacryloyloxy groups as ethylenically unsaturated groups.

Preferred monomers containing siloxane groups that it is possible to use are vinyltrialkoxysilanes, for example, vinyltrimethoxysilane, alkylvinyldialkoxysilanes, acryloyloxyalkyltrialkoxysilanes, or methacryloyloxyalkyltrialkoxysilanes, such as acryloyloxyethyltrimethoxysilane, methacryloyloxyethyltrimethoxysilane, acryloyloxypropyltrimethoxysilane or methacryloyloxypropyltrimethoxysilane, for example.

Further examples of such monomers are methacryloyloxypropyltrimethoxysilane, vinyltrimethoxysilane, vinyltriethoxysilane, vinylacetoxysilane, vinyltris(β-methoxy-ethoxy)silane, γ-methacryloyloxypropylmethyldimethoxysilane, acryloyloxypropyldi-methoxysilane, N-β-(Vinylbenzylaminoethyl)γ-aminopropyltrimethoxysilane and mixtures thereof.

Based on the ethylenically unsaturated monomers used to prepare the addition polymers the ethylenically unsaturated alkoxysilane monomers are used preferably in a fraction of from 0.05 to 10% by weight, preferably from 0.05 to 3% by weight, in particular from 0.1 to 1% by weight.

It has been found in accordance with the invention that the aqueous dispersions indicated above and described in more detail below exhibit particular advantages in the priming of mineral substrates, especially glasslike substrates. Mineral substrates are substrates derived from inorganic, rock-forming minerals. These can be sulfides, halides, oxides/hydroxides, carbonates,. nitrates, borates, sulfates, chromates, molybdates, tungstates, phosphates, arsenates, vanadates or silicates. They are preferably silicates. Substrates regarded as mineral substrates are those composed of at least 50% by weight of mineral materials. With preference they are composed of at least 80% by weight, and in particular completely, of minerals.

By “grasslike substrates” are meant those substrates composed predominantly of inorganic glasses. Based on the glasslike substrate overall, the fraction of inorganic glass is preferably at least 80%, more preferably at least 95%. With special preference the glasslike substrate is composed only of inorganic glass. This glass is an oxidic melt product based on silicates. Possible constituents of the glass are, in particular, silica, calcium oxide, sodium oxide, boron trioxide, alumina, lead oxide, magnesium oxide, barium oxide, potassium oxide, and further additions. Reference may be made to Römpp, Chemie Lexikon, 9^{th} edition, entry “glass”. In table 1 therein, different glass compositions are indicated by way of example. The glasslike substrates are, in particular, glazed tiles.

The expression “primer” refers to an application to the mineral, especially glasslike substrates, as an intermediate coat and tie coat. The primer ought in particular to exhibit good initial adhesion to glass.

It has been found in accordance with the invention that the polymer/inorganic nanocomposite dispersions described lead to particularly advantageous priming of mineral substrates. The dispersions can be employed without solvent and, as compared with known polymer dispersions, exhibit advantages in adhesion and in crushing. These advantageous properties are also achievable by blending polymer dispersions with the finely divided inorganic solids, especially silica sols. The adhesion, particularly to glasslike or silicatic substrates, is markedly improved over that of known dispersions even following short-term water storage. In contradistinction to the prior art, the adhesion to the substrate is at the fore in accordance with the invention, and not the protection of the substrate or a water vapor barrier.

The adhesion can be tested in particular by means of crosshatch tests.

DE-A-199 42 777 describes a process for preparing aqueous composite-particle dispersions wherein the dispersed inorganic solid particles and the radical-generating and/or dispersing components used in the free-radically initiated aqueous emulsion polymerization have opposite charges.

DE-A-100 00 281 describes a process for preparing aqueous composite-particle dispersions wherein the dispersed inorganic solid particles have a nonzero electrophoretic mobility and wherein special comonomers are used in the aqueous emulsion polymerization.

To prepare the aqueous dispersion it is preferred to perform polymerization in the presence of at least one anionic, cationic and nonionic dispersant by the method of free-radical aqueous emulsion polymerization,

a) a stable aqueous dispersion of the at least one inorganic solid is used which is characterized in that at an initial solids concentration of ≧1% by weight, based on the aqueous dispersion of the at least one inorganic solid, one hour after its preparation it still contains more than 90% by weight of the originally dispersed solid in dispersed form and its dispersed solid particles have a diameter ≦100 nm,

b) the dispersed solid particles of the at least one inorganic solid in an aqueous standard potassium chloride solution at a pH corresponding to the pH of the aqueous reaction medium before addition of the dispersants is commenced exhibit a nonzero electrophoretic mobility,

c) before commencement of the addition of the mixture of the ethylenically unsaturated monomers, at least one anionic, cationic, and nonionic dispersant is added to the aqueous dispersion of solid particles,

d) thereafter from 0.01 to 30% by weight of the total amount of the mixture of the monomers is added to the aqueous dispersion of solid particles and polymerization is performed up to a conversion of at least 90%, and

e) subsequently the remainder of the mixture of monomers is added under polymerization conditions at the rate at which it is consumed.

Suitable for the preparation are all those finely divided inorganic solids which form stable aqueous dispersions which at an initial solids concentration of ≧1% by weight, based on the aqueous dispersion of the at least one inorganic solid, one hour after their preparation, without stirring or shaking, still contain more than 90% by weight of the originally dispersed solid in dispersed form and whose dispersed solid particles have a diameter ≦100 nm and which, furthermore, at a pH corresponding to the pH of the aqueous reaction medium before addition of the dispersants is commenced, exhibit a nonzero electrophoretic mobility.

The quantitative determination of the initial solids concentration and the solids concentration after one hour, and also the determination of the particle diameters, is made by the method of the analytical ultracentrifuge (on this point cf. S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight-Cell-AUC-Multiplexer: High Resolution Particle Size Distribution and Density Gradient Techniques, W. Mächtle, pages 147 to 175). The values specified for the particle diameters correspond to what are termed the d₅₀ values.

Suitable finely divided inorganic solids which can be used in accordance with the invention include metals, metal compounds, such as metal oxides and metal salts, and also semimetal compounds and nonmetal compounds. Finely divided metal powders which can be used are noble metal colloids, such as palladium, silver, ruthenium, platinum, gold, and rhodium, for example, and their alloys. Examples that may be mentioned of finely divided metal oxides include titanium dioxide (commercially available, for example, as Hombitec® grades from Sachtleben Chemie GmbH), zirconium(IV) oxide, tin(II) oxide, tin(IV) oxide (commercially available for example, as Nyacol® SN grades from Akzo-Nobel), alumina (commercially available, for example, as Nyacol® AL grades from Akzo-Nobel), barium oxide, magnesium oxide, various iron oxides, such as iron(II) oxide (wuestite), iron(III) oxide (haematite) and iron(II/III) oxide (magnetite), chromium(III) oxide, antimony(III) oxide, bismuth(III) oxide, zinc oxide (commercially available, for example, as Sachtotec® grades from Sachtleben Chemie GmbH), nickel(II) oxide, nickel(III) oxide, cobalt(II) oxide, cobalt(III) oxide, copper(II) oxide, yttrium(III) oxide (commercially available, for example, as Nyacol® YTTRIA grades from Akzo-Nobel), cerium(IV) oxide (commercially available, for example, as Nyacol® CEO2 grades from Akzo-Nobel), amorphous and/or in their different crystal modifications, and also their hydroxy oxides, such as, for example, hydroxytitanium(IV) oxide, hydroxyzirconium(IV) oxide, hydroxyalumina (commercially available, for example, as Disperal® grades from Condea-Chemie GmbH) and hydroxyiron(III) oxide, amorphous and/or in their different crystal modifications. The following metal salts, amorphous and/or in their different crystal structures, can be used in principle in accordance with the invention: sulfides, such as iron(II) sulfide, iron(III) sulfide, iron(II) disulfide (pyrite), tin(II) sulfide, tin(IV) sulfide, mercury(II) sulfide, cadmium(II) sulfide, zinc sulfide, copper(II) sulfide, silver sulfide, nickel(II) sulfide, cobalt(II) sulfide, cobalt(III) sulfide, manganese(II) sulfide, chromium(III) sulfide, titanium(II) sulfide, titanium(III) sulfide, titanium(IV) sulfide, zirconium(IV) sulfide, antimony(III) sulfide, bismuth(III) sulfide, hydroxides, such as tin(II) hydroxide, aluminum hydroxide, magnesium hydroxide, calcium hydroxide, barium hydroxide, zinc hydroxide, iron(II) hydroxide, iron(III) hydroxide, sulfates, such as calcium sulfate, strontium sulfate, barium sulfate, lead(IV) sulfate, carbonates, such as lithium carbonate, magnesium carbonate, calcium carbonate, zinc carbonate, zirconium(IV) carbonate, iron(II) carbonate, iron(III) carbonate, orthophosphates, such as lithium orthophosphate, calcium orthophosphate, zinc orthophosphate, magnesium orthophosphate, aluminum orthophosphate, tin(III) orthophosphate, iron(II) orthophosphate, iron(III) orthophosphate, metaphosphates, such as lithium metaphosphate, calcium metaphosphate, aluminum metaphosphate, pyrophosphates, such as magnesium pyrophosphate, calcium pyrophosphate, zinc pyrophosphate, iron(III) pyrophosphate, tin(II) pyrophosphate, ammonium phosphates, such as magnesium ammonium phosphate, zinc ammonium phosphate, hydroxylapatite [Ca₅{(PO₄)₃OH}], orthosilicates, such as lithium orthosilicate, calcium/magnesium orthosilicate, aluminum orthosilicate, iron(II) orthosilicate, iron(III) orthosilicate, magnesium orthosilicate, zinc orthosilicate, zirconium(III) orthosilicate, zirconium(IV) orthosilicate, metasilicates, such as lithium metasilicate, calcium/magnesium metasilicate, calcium metasilicate, magnesium metasilicate, zinc metasilicate, phyllosilicates, such as sodium aluminum silicate and sodium magnesium silicate particularly in spontaneously delaminating form, such as, for example, Optigel® SH (trademark of Südchemie AG), Saponit® SKS-20 and Hektorit® SKS 21 (trademarks of Hoechst AG) and also Laponite® RD and Laponite® GS (trademarks of Laporte Industries Ltd.), aluminates, such as lithium aluminate, calcium aluminate, zinc aluminate, borates, such as magnesium metaborate, magnesium orthoborate, oxalates, such as calcium oxalate, zirconium(IV) oxalate, magnesium oxalate, zinc oxalate, aluminum oxalate, tartrates, such as calcium tartrate, acetylacetonates, such as aluminum acetylacetonate, iron(II) acetylacetonate, salicylates, such as aluminum salicylate, citrates, such as calcium citrate, iron(II) citrate, zinc citrate, palmitates, such as aluminum palmitate, calcium palmitate, magnesium palmitate, stearates, such as aluminum stearate, calcium stearate, magnesium stearate, zinc stearate, laurates, such as calcium laurate, linoleates, such as calcium linoleate, oleates, such as calcium oleate, iron(II) oleate or zinc oleate.

As an essential semimetal compound which can be used in accordance with the invention mention may be made of amorphous silica and/or silica present in different crystal structures. Silica suitable in accordance with the invention is available commercially and can be obtained, for example, as Aerosil® (trademark of Degussa AG), Levasil® (trademark of Bayer AG), Ludox® (trademark of DuPont), Nyacol® and Bindzil® (trademarks of Akzo-Nobel) and Snowtex® (trademark of Nissan Chemical Industries, Ltd.). Nonmetal compounds suitable in accordance with the invention are, for example, colloidal graphite or diamond.

Particularly suitable finely divided inorganic solids are those whose solubility in water at 20° C. and 1 bar (absolute) is ≦1 g/l, preferably ≦0.1 g/l and in particular ≦0.01 g/l. Particular preference is given to compounds selected from the group encompassing silica, alumina, tin(IV) oxide, yttrium(III) oxide, cerium(IV) oxide, hydroxyalumina, calcium carbonate, magnesium carbonate, calcium orthophosphate, magnesium orthophosphate, calcium metaphospate, magnesium metaphosphate, calcium pyrophosphate, magnesium pyrophosphate, iron(II) oxide, iron(III) oxide, iron(II/III) oxide, titanium dioxide, hydroxylapatite, zinc oxide, and zinc sulfide. Particular preference is given to silica sols which have an electrophoretic mobility with a negative sign.

In the process of the invention it is also possible to use with advantage the commercially available compounds of the Aerosile®, Levasil®, Ludox®, Nyacol® and Bindzil® grades (silica), Disperal® grades (hydroxyalumina), Nyacol® AL grades (alumina), Hombitec® grades (titanium dioxide) Nyacol® SN grades, (tin(IV) oxide), Nyacol® YTTRIA grades (yttrium(III) oxide), Nyacol® CEO2 grades (cerium(IV) oxide) and Sachtotec® grades (zinc oxide).

The finely divided inorganic solids which can be used in accordance with the invention are preferably such that the solid particles dispersed in the aqueous reaction medium have a particle diameter of ≦100 nm. Employed successfully are those finely divided inorganic solids whose dispersed particles have a particle diameter >0 nm but ≦90 nm, ≦80 nm, ≦70 nm, ≦60 nm, ≦50 nm, ≦40 nm, ≦30 nm, ≦20 nm or ≦10 nm and all values in between. Used with advantage are finely divided inorganic solids which have a particle diameter ≦50 nm. The particle diameters are determined by the method of the analytical ultracentrifuge.

The obtainability of finely divided solids is known in principle to the skilled worker and they are obtained, for example, by precipitation reactions or chemical reactions in the gas phase (on this point cf. E. Matijevic, Chem. Mater. 1993, 5, pages 412 to 426; Ullmann's Encyclopedia of Industrial Chemistry, Vol. A 23, pages 583 to 660, Verlag Chemie, Weinheim, 1992; D. F. Evans, H. Wennerström in The Colloidal Domain, pages 363 to 405, Verlag Chemie, Weinheim, 1994 and R. J. Hunter in Foundations of Colloid Science, Vol. I, pages 10 to 17, Clarendon Press, Oxford, 1991).

The stable dispersion of solids is frequently prepared directly during the synthesis of the finely divided inorganic solids in an aqueous medium or alternatively by dispersing the finely divided inorganic solid into the aqueous medium. Depending on the way in which the finely divided inorganic solids are prepared this is done either directly, in the case, for example, of precipitated or pyrogenic silica, alumina, etc., or with the aid of suitable auxiliary equipment, such as dispersers or ultrasonic sonotrodes, for example.

In accordance with the invention, however, finely divided inorganic solids suitable with preference are only those whose aqueous solids dispersion, at an initial solids concentration of ≧1% by weight, based on the aqueous dispersion of the finely divided inorganic solid, one hour following its preparation, or by stirring up or shaking up the sedimented solids, without further stirring or shaking, still contains more than 90% by weight of the originally dispersed solid in dispersed form and whose dispersed solid particles have a diameter ≦100 nm. Customary initial solids concentrations are ≦60% by weight. With advantage, however, it is also possible to use initial solids concentrations ≦55% by weight, ≦50% by weight, ≦45% by weight, ≦40% by weight, ≦35% by weight, ≦30% by weight, ≦25% by weight, ≦20% by weight, ≦15% by weight, ≦10% by weight, ≧2% by weight, ≧3% by weight, ≧4% by weight or ≧5% by weight and all values in between, based in each case on the aqueous dispersion of the finely divided inorganic solid. Based on 100 parts by weight of the mixture of ethylenically unsaturated monomers use is made in accordance with the invention of from 1 to 1000 parts by weight, generally from 5 to 300 parts by weight, and frequently from 10 to 200 parts by weight of the at least one finely divided inorganic solid.

It is advantageous that in an aqueous standard potassium chloride solution at a pH which corresponds to the pH of the aqueous reaction medium before the addition of the dispersants is commenced the dispersed solid particles have a nonzero electrophoretic mobility. The pH is determined at 20° C. and 1 bar (absolute) using commercially customary pH meters on an aqueous dispersion which in addition to the at least one finely divided inorganic solid may also contain acids or bases for setting the pH.

The method of determining the electrophoretic mobility is known to the skilled worker (cf. e.g. R. J. Hunter, Introduction to modem Colloid Science, section 8.4, pages 241 to 248, Oxford University Press, Oxford, 1993, and K. Oka and K. Furusawa, in Electrical Phenomena at Interfaces, Surfactant Science Series, Vol. 76, Section 8, pages 151 to 232, Marcel Dekker, New York, 1998). The electrophoretic mobility of the solid particles dispersed in the aqueous reaction medium is determined using a commercial electrophoresis instrument, an example being the Zetasizer 3000 from Malvern Instruments Ltd., at 20° C. and 1 bar (absolute). For this purpose the aqueous dispersion of solid particles is diluted with a pH-neutral 10 millimolar (mM) aqueous potassium chloride solution (standard potassium chloride solution) until the concentration of solid particles is from about 50 to 100 mg/l. The adjustment of the samples to the pH possessed by the aqueous reaction medium before the addition of the dispersants is commenced is made using the customary inorganic acids, such as dilute hydrochloric acid or nitric acid, for example, or bases, such as dilute sodium hydroxide or potassium hydroxide solution, for example. The migration of the dispersed solid particles in the electrical field is detected by means of what is known as electrophoretic light scattering (cf., e.g., B. R. Ware and W. H. Flygare, Chem. Phys. Lett. 1971, 12, pages 81 to 85). In this method the sign of the electrophoretic mobility is defined by the migrational direction of the dispersed solid particles; in other words, if the disperse solid particles migrate to the cathode, their electrophoretic mobility is positive, while if they migrate to the anode, it is negative.

A suitable parameter for influencing or adjusting the electrophoretic mobility of dispersed solid particles to a certain extent is the pH of the aqueous reaction medium. Protonation and, respectively, deprotionation of the dispersed solid particles alter the electrophoretic mobility positively in the acidic pH range (pH<7) and negatively in the alkaline range (pH>7). A pH range suitable for the process of the invention is that within which a free-radically initiated aqueous emulsion polymerization can be conducted. This pH range is generally from 1 to 12, frequently from 1.5 to 11, and often from 2 to 10.

The pH of the aqueous reaction medium can be adjusted by means of commercially customary acids, such as dilute hydrochloric, nitric or sulfuric acid, for example, or bases, such as dilute sodium or potassium hydroxide solution, for example. In many cases it is favorable if a portion or all of the amount of acid or base used for pH adjustment is added to the aqueous reaction medium before the at least one finely divided inorganic solid.

It is advantageous if, when the dispersed solid particles under the aforementioned pH conditions

have an electrophoretic mobility with a negative sign, per 100 parts by weight of the at least one ethylenically unsaturated monomer, from 0.01 to 10 parts by weight, preferably from 0.05 to 5 parts by weight, and with particular preference from 0.1 to 3 parts by weight of at least one cationic dispersant, from 0.01 to 100 parts by weight, preferably from 0.05 to 50 parts by weight, and with particular preference from 0.1 to 20 parts by weight of at least one nonionic dispersant, and at least one anionic dispersant are used, the amount thereof being such that the equivalent ratio of anionic to cationic dispersant is greater than 1, or

have an electrophoretic mobility with a positive sign, per 100 parts by weight of the at least one ethylenically unsaturated monomer, from 0.01 to 10 parts by weight, preferably from 0.05 to 5 parts by weight, and with particular preference from 0.1 to 3 parts by weight of at least one anionic dispersant, from 0.01 to 100 parts by weight, preferably from 0.05 to 50 parts by weight, and with particular preference from 0.1 to 20 parts by weight of at least one nonionic dispersant, and at least one cationic dispersant are used, the amount thereof being such that the equivalent ratio of cationic to anionic dispersant is greater than 1.

In accordance with the invention dispersants are used which maintain not only the finely divided inorganic solid particles but also the monomer droplets and the composite particles formed in dispersed distribution in the aqueous phase and hence ensure the stability of the aqueous composite-particle dispersion produced. Suitable dispersants include not only the protective colloids commonly used to carry out free-radical aqueous emulsion polymerizations but also emulsifiers.

A detailed description of the suitable protective colloids is given in Houben-Weyl, Methoden der organischen Chemie, Volume XIV/1, Makromolekulare Stoffe [Macromolecular substances], Georg-Thieme-Verlag, Stuttgart, 1961, pages 411 to 420.

Examples of suitable neutral protective colloids are polyvinyl alcohols, polyalkylene glycols, cellulose derivatives, starch derivatives and gelatin derivatives.

Suitable anionic protective colloids, i.e., protective colloids whose dispersing component has at least one negative electric charge, include, for example, polyacrylic acids and polymethacrylic acids and their alkali metal salts, acrylic acid, methacrylic acid, 2-acrylamido-2-methylpropanesulfonic acid, 4-styrenesulfonic acid and/or maleic anhydride copolymers and their alkali metal salts, and also alkali metal salts of sulfonic acids of high molecular mass compounds, such as polystyrene, for example.

Suitable cationic protective colloids, i.e., protective colloids whose dispersing component has at least one positive electrical charge, are, for example, the derivatives, alkylated and/or protonated on the nitrogen, of N-vinylpyrrolidone, N-vinylcaprolactam, N-vinylcarbazole, 1-vinylimidazole, 2-vinylimidazole, 2-vinylpyridine, 4-vinylpyridine, acrylamide, methacrylamide, amino-bearing acrylates, methacrylates, acrylamide and/or methacrylamide homopolymers and copolymers.

Naturally it is also possible to use mixtures of emulsifiers and/or protective colloids. Frequently employed as dispersants are exclusively emulsifiers, whose relative molecular weights, unlike those of the protective colloids, are normally below 1000. Where mixtures of surface-active substances are used the individual components must of course be compatible with one another, which in case of doubt can be checked by means of a few preliminary tests. An overview of suitable emulsifiers is given in Houben-Weyl, Methoden der organischen Chemie, Volume XIV/1, Makromolekulare Stoffe, Georg-Thieme-Verlag, Stuttgart, 1961, pages 192 to 208.

Examples of common nonionic emulsifiers are ethoxylated mono-, di-, and tri-alkylphenols (EO units: 3 to 50, alkyl: C₄ to C₁₂) and also ethoxylated fatty alcohols (EO units: 3 to 80; alkyl: C₈ to C₃₆). Examples thereof are the Lutensol® A grades (C₁₂C₁₄ fatty alcohol ethoxylates, EO units: 3 to 8), Lutensol® AO grades (C₁₃C₁₅ oxo alcohol ethoxylates, EO units: 3 to 30), Lutensol® AT grades (C₁₆C₁₈ fatty alcohol ethoxylates, EO units: 11 to 80), Lutensol® ON grades (C₁₀-oxo alcohol ethoxylates, EO units: 3 to 11), and the Lutensol® TO grades (C₁₃ oxo alcohol ethoxylates, EO units: 3 to 20) of BASF AG.

Customary anionic emulsifiers are, for example, alkali metal salts and ammonium salts of alkyl sulfates (alkyl: C₈ to C₁₂), of sulfuric acid monoesters with ethoxylated alkanols (EO units: 4 to 30, alkyl: C₁₂ to C₁₈) and ethoxylated alkyl phenols (EO units: 3 to 50, alkyl: C₄ to C₁₂), of alkylsulfonic acids (alkyl: C₁₂ to C₁₈) and of alkylarylsulfonic acids (alkyl: C₉ to C₁₈).

Compounds which have been found to be further anionic emulsifiers are also those of the general formula I

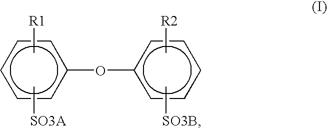

in which R¹ and R² are hydrogen atoms or C₄ to C₂₄-alkyl and are not simultaneously hydrogen atoms, and A and B can be alkali metal ions and/or ammonium ions. In the general formula I R¹ and R² are preferably linear or branched alkyl radicals having 6 to 18 carbon atoms, especially having 6, 12, and 16 carbon atoms or —H, with R¹ and R² not both simultaneously being hydrogen atoms. A and B are preferably sodium, potassium or ammonium, with sodium being particularly preferred. Particularly advantageous compounds I are those in which A and B are sodium, R¹ is a branched alkyl radical having 12 carbon atoms, and R² is a hydrogen atom or R¹. Use is frequently made of technical-grade mixtures containing a fraction of from 50 to 90% by weight of the monoalkylated product, such as Dowfax® 2A1 (trademark of Dow Chemical Company), for example. The compounds I are general knowledge, for example, from U.S. Pat. No. 4,269,749, and available commercially.

Suitable cation-active emulsifiers are generally C₆ to C₁₈ alkyl-, aralkyl- or heterocycle-containing primary, secondary, tertiary or quaternary ammonium salts, alkanol ammonium salts, pyridinium salts, imidazolinium salts, oxazolinium salts, morpholinium salts, thiazolinium salts, and also salts of amine oxides, quinolinium salts, isoquinolinium salts, tropylium salts, sulfonium salts and phosphonium salts. By way of example mention may be made of dodecylammonium acetate or the corresponding hydrochloride, the chlorides or acetates of the various 2-(N,N,N-trimethylammonium)ethyl esters of paraffinic acids, N-cetylpyridinium chloride, N-laurylpyridinium sulfate, and N-cetyl-N,N,N-trimethylammonium bromide, N-dodecyl-N,N,N-trimethylammonium bromide, N-octyl-N,N,N-trimethylammonium bromide, N,N-distearyl-N,N-dimethylammonium chloride and the gemini surfactant N,N′-(lauryldimethyl)ethylenediamine dibromide. Numerous further examples are given in H. Stache, Tensid-Taschenbuch, Carl-Hanser-Verlag, Munich, Vienna, 1981 and in McCutcheon's, Emulsifiers & Detergents, MC Publishing Company, Glen Rock, 1989.

The term “equivalent ratio” of anionic to cationic dispersant is intended to denote the ratio of the number of moles of the anionic dispersant used multiplied by the number of anionic groups present per mole of the anionic dispersant, divided by the number of moles of the cationic dispersant used multiplied by the number of cationic groups present per mole of the cationic dispersant. The same applies to the equivalent ratio of cationic to anionic dispersant.

All of the at least one anionic, cationic, and nonionic dispersant used in the process can be included in the initial charge in the aqueous dispersion of solids. It is, however, also possible to include only a portion of said dispersants' in the initial charge in the aqueous dispersion of solids and to add the remaining amounts during the free-radical emulsion polymerization, continuously or in batches. It is, however, advantageous, both before and during the free-radically initiated emulsion polymerization, to maintain the abovementioned equivalent ratio of anionic and cationic dispersant as a function of the electrophoretic sign of the finely divided solid. If, therefore, inorganic solid particles are used which under the aforementioned pH conditions have an electrophoretic mobility with a negative sign, then the equivalent ratio of anionic to cationic dispersant throughout the emulsion polymerization should be greater than 1. Correspondingly, in the case of inorganic solid particles having an electrophoretic mobility with a positive sign, the equivalent ratio of cationic to anionic dispersant throughout the emulsion polymerization should be greater than 1. It is favorable if the equivalent ratio is ≧2, ≧3, ≧4, ≧5, ≧6, ≧7, or ≧10, an equivalent ratio in the range between 2 and 5 being especially favorable.

It is advantageous if a portion or all of the at least one nonionic dispersant is added before the at least one anionic and cationic dispersant.

The implementation of a free-radically initiated aqueous emulsion polymerization of ethylenically unsaturated monomers is described in many instances in the prior art and is therefore sufficiently well known to the skilled worker [cf., e.g., Encyclopedia of Polymer Science and Engineering, Vol. 8, pages 659 to 677, John Wiley & Sons, Inc., 1987; D. C. Blackley, Emulsion Polymerisation, pages 155 to 465, Applied Science Publishers, Ltd., Essex, 1975; D. C. Blackley, Polymer Latices, 2^{nd} Edition, Vol. 1, pages 33 to 415, Chapman & Hall, 1997; H. Warson, The Applications of Synthetic Resin Emulsions, pages 49 to 244, Ernest Benn, Ltd., London, 1972; D. Diederich, Chemie in unserer Zeit 1990, 24, pages 135 to 142, Verlag Chemie, Weinheim; J. Piirma, Emulsion Polymerisation, pages 1 to 287, Academic Press, 1982; F. Hölscher, Dispersionen synthetischer Hochpolymerer, pages 1 to 160, Springer-Verlag, Berlin, 1969 and patent DE-A 40 03 422]. It is customarily carried out by dispersely distributing the ethylenically unsaturated monomers in the aqueous medium, using dispersants, and polymerizing them by means of at least one free-radical polymerization initiator. The process of the invention differs from this procedure only in the additional presence of at least one finely divided inorganic solid which has a nonzero electrophoretic mobility and in the use of a specific dispersant combination.

Monomers which are suitable as ethylenically unsaturated monomers, in addition to the alkoxy silane monomers, for the process of the invention include in particular monomers which lend themselves easily to free-radical polymerization, such as ethylene, vinylaromatic monomers, such as styrene, α-methylstyrene, o-chlorostyrene or vinyl toluenes, esters of vinyl alcohol and monocarboxylic acids having 1 to 18 carbon atoms, such as vinyl acetate, vinyl propionate, vinyl-n-butyrate, vinyl laurate and vinyl stearate, esters of α,β-monoethylenically unsaturated monocarboxylic and dicarboxylic acids preferably having 3 to 6 carbon atoms, such as, in particular, acrylic acid, methacrylic acid, maleic acid, fumaric acid, and itaconic acid, with alkanols having generally 1 to 12, preferably 1 to 8, and in particular 1 to 4 carbon atoms, such as, in particular, methyl, ethyl, n-butyl-, iso-butyl and 2-ethylhexyl acrylate and methacrylate, dimethyl maleate, di-n-butyl maleate, nitriles of α,β-monoethylenically unsaturated carboxylic acids, such as acrylonitrile, and also C₄₋₈ conjugated dienes, such as 1,3-butadiene and isoprene. These monomers generally constitute the principal monomers, which, based on the total amount of the monomers to be polymerized by the process of the invention, normally account for a fraction of ≧50% by weight, ≧80% by weight or ≧90% by weight. As a general rule these monomers are of only moderate to low solubility in water under standard conditions [20° C., 1 bar (absolute)].

Monomers which customarily increase the internal strength of the films of the polymer matrix normally have at least one epoxy, hydroxyl, N-methylol or carbonyl group or at least two nonconjugated ethylenically unsaturated double bonds. Examples thereof are monomers having two vinyl radicals, monomers having two vinylidene radicals, and monomers having two alkenyl radicals. Particularly advantageous in this context are the diesters of dihydric alcohols with α,β-monoethylenically unsaturated monocarboxylic acids, among which acrylic and methacrylic acid are preferred. Examples of this kind of monomer having two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, and also divinylbenzene, vinyl methacrylate, vinyl acrylate, allyl methacrylate, allyl acrylate, diallylmaleate, diallyl fumarate, methylenebisacrylamide, cyclopentadienyl acrylate, triallyl cyanurate or triallyl isocyanurate. Of particular importance in this context are also the methacrylic and acrylic C₁-C₈ hydroxyalkyl esters, such as n-hydroxyethyl, n-hydroxypropyl or n-hydroxybutyl acrylate and methacrylate, and also compounds such as diacetonacrylamide and acetylacetoxyethylacrylate and methacrylate. In accordance with the invention the abovementioned monomers are copolymerized in amounts of up to 5% by weight, based on the total amount of the monomers to be polymerized.

In addition to this it is also possible to make use, as monomers, of those ethylenically unsaturated monomers A which contain either at least one acid group and/or its corresponding anion or of those ethylenically unsaturated monomers B which contain at least one amino, amido, ureido or N-heterocyclic group and/or the ammonium derivatives thereof that are alkylated or protonated on the nitrogen. Based on the total monomer amount, the amount of monomers A or monomers B, respectively, is up to 10% by weight, often from 0.1 to 7% by weight, and frequently from 0.2 to 5% by weight.

The monomers used as monomers A are ethylenically unsaturated and have at least one acid group. This acid group can be, for example, a carboxylic acid, sulfonic acid, sulfuric acid, phosphoric acid and/or phosphonic acid group. Examples of monomers A are acrylic acid, methacrylic acid, maleic acid, fumaric acid, itaconic acid, crotonic acid, 4-styrenesulfonic acid, 2-methacryloyloxyethylsulfonic acid, vinylsulfonic acid, and vinylphosphonic acid, and also phosphoric monoesters of n-hydroxyalkyl acrylates and n-hydroxyalkylmethacrylates, such as, for example, phosphoric monoesters of hydroxyethyl acrylate, n-hydroxypropyl acrylate, n-hydroxybutyl acrylate, and hydroxyethyl methacrylate, n-hydroxypropyl methacrylate or n-hydroxybutyl methacrylate. In accordance with the invention it is, however, also possible to use the ammonium salts and alkali metal salts of the aforementioned ethylenically unsaturated monomers containing at least one acid group. As the alkali metal particular preference is given to sodium and potassium. Examples thereof are the ammonium, sodium, and potassium salts of acrylic acid, methacrylic acid, maleic acid, fumaric acid, itaconic acid, cronotic acid, 4-styrenesulfonic acid, 2-methacryloyloxyethylsulfonic acid, vinylsulfonic acid, and vinylphosphonic acid, and also the mono- and di-ammonium, -sodium, and -potassium salts of the phosphoric monoesters of hydroxyethyl acrylate, n-hydroxypropyl acrylate, n-hydroxybutyl acrylate and hydroxyethyl methacrylate, n-hydroxypropyl methacrylate or n-hydroxybutyl methacrylate.

Preference is given to using acrylic acid, methacrylic acid, maleic acid, fumaric acid, itaconic acid, crotonic acid, 4-styrenesulfonic acid, 2-methacryloyloxyethylsulfonic acid, vinylsulfonic acid and vinylphosphonic acid.

Monomers used as monomers B are ethylenically unsaturated and contain at least one amino, amido, ureido or n-heterocyclic group and/or the ammonium derivatives thereof that are alkylated or protonated on the nitrogen.

Examples of monomers B containing at least one amino group are 2-aminoethyl acrylate, 2-aminoethyl methacrylate, 3-aminopropyl acrylate, 3-aminopropyl methacrylate, 4-amino-n-butyl acrylate, 4-amino-n-butyl methacrylate, 2-(N-methylamino)ethyl acrylate, 2-(N-methylamino)ethyl methacrylate, 2-(N-ethylamino)ethyl acrylate, 2-(N-ethylamino)ethyl methacrylate, 2-(N-n-propylamino)ethyl acrylate, 2-(N-n-propylamino)ethyl methacrylate, 2-(N-iso-propylamino)ethyl acrylate, 2-(N-iso-propylamino)ethyl methacrylate, 2-(N-tert-butylamino)ethyl acrylate, 2-(N-tert-butylamino)ethyl methacrylate (commercially available, for example, as Norsocryl® TBAEMA from Elf Atochem), 2-(N,N-dimethylamino)ethyl acrylate (commercially available, for example, as Norsocryl® ADAME from Elf Atochem), 2-(N,N-dimethylamino)ethyl methacrylate (commercially available, for example, as Norsocryl® MADAME from Elf Atochem), 2-(N,N-diethylamino)ethyl acrylate, 2-(N,N-diethylamino)ethyl methacrylate, 2-(N,N-di-n-propylamino)ethyl acrylate, 2-(N,N-di-n-propylamino)ethyl methacrylate, 2-(N,N-di-iso-propylamino)ethyl acrylate, 2-(N,N-di-iso-propylamino)ethyl methacrylate, 3-(N-methylamino)propyl acrylate, 3-(N-methylamino)propyl methacrylate, 3-(N-ethylamino)propyl acrylate, 3-(N-ethylamino)propyl methacrylate, 3-(N-n-propylamino)propyl acrylate, 3-(N-n-propylamino)propyl methacrylate, 3-(N-iso-propylamino)propyl acrylate, 3-(N-iso-propylamino)propyl methacrylate, 3-(N-tert-butylamino)propyl acrylate, 3-(N-tert-butylamino)propyl methacrylate, 3-(N,N-dimethylamino)propyl acrylate, 3-(N,N-dimethylamino)propyl methacrylate, 3-(N,N-diethylamino)propyl acrylate, 3-(N,N-diethylamino)propyl methacrylate, 3-(N,N-di-n-propylamino)propyl acrylate, 3-(N,N-di-n-propylamino)propyl methacrylate, 3-(N,N-di-iso-propylamino)propyl acrylate and 3-(N,N-di-iso-propylamino)propyl methacrylate.

Examples of monomers B which contain at least one amido group are acrylamide, methacrylamide, N-methylacrylamide, N-methylmethacrylamide, N-ethylacrylamide, N-ethylmethacrylamide, N-n-propylacrylamide, N-n-propylmethacrylamide, N-iso-propylacrylamide, N-iso-propylmethacrylamide, N-tert-butylacrylamide, N-tert-butylmethacrylamide, N,N-dimethylacrylamide, N,N-dimethylmethacrylamide, N,N-diethylacrylamide, N,N-diethylmethacrylamide, N,N-di-n-propylacrylamide, N,N-di-n-propylmethacrylamide, N,N-di-iso-propylacrylamide, N,N-di-iso-propylmethacrylamide, N,N-di-n-butylacrylamide, N,N-di-n-butylmethacrylamide, N-(3-N′,N′-dimethyl aminopropyl)methacrylamide, diacetoneacrylamide, N,N′-methylenebisacrylamide, N-(diphenylmethyl)acrylamide, N-cyclohexylacrylamide, and also N-vinylpyrrolidone and N-vinylcaprolactam.

Examples of monomers B containing at least one ureido group are N,N′-divinylethylene urea and 2-(1-imidazolin-2-onyl)ethylmethacrylate (commercially available, for example, as Norsocryl® 100 from Elf Atochem).

Examples of monomers B containing at least one N-heterocyclic group are 2-vinylpyridine, 4-vinylpyridine, 1-vinylimidazole, 2-vinylimidazole and N-vinylcarbazole.

Preference is given to using the following compounds: 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide and 2-(1-imidazolin-2-onyl)ethyl methacrylate.

Depending on the pH of the aqueous reaction medium, some or all of the aforementioned nitrogen-containing monomers B may be present in the quaternary ammonium form with protonation on the nitrogen.

Examples that may be mentioned of monomers B having a quaternary alkylammonium structure on the nitrogen include 2-(N,N,N-trimethylammonium)ethylacrylate chloride (commercially available, for example, as Norsocryl® ADAMQUAT MC 80 from Elf Atochem), 2-(N,N,N-trimethylammonium)ethylmethacrylate chloride (commercially available, for example, as Norsocryl® MADQUAT MC 75 from Elf Atochem), 2-(N-methyl-N,N-diethylammonium)ethylacrylate chloride, 2-(N-methyl-N,N-diethyl ammonium)ethyl methacrylate chloride, 2-(N-methyl-N,N-dipropyl ammonium)ethylacrylate chloride, 2-(N-methyl-N,N-dipropylammonium)ethyl methacrylate, 2-(N-benzyl-N,N-dimethyl-ammonium)ethylacrylate chloride (commercially available as Norsocryl® ADAMQUAT BZ 80 from Elf Atochem), 2-(N-benzyl-N,N-dimethylammonium)ethyl methacrylate chloride (commercially available, for example as Norsocryl® MADQUAT BZ 75 from Elf Atochem), 2-(N-benzyl-N,N-diethyl-ammonium)ethyl acrylate chloride, 2-(N-benzyl-N,N-diethylammonium)ethyl methacrylate chloride, 2-(N-benzyl-N,N-dipropylammonium)ethylacrylate chloride, 2-(N-benzyl-N,N-dipropylammonium)ethyl methacrylate chloride, 3-(N,N,N-trimethyl-ammonium)propyl acrylate chloride, 3-(N,N,N-trimethylammonium)propyl-methacrylate chloride, 3-(N-methyl-N,N-diethylammonium)propyl acrylate chloride, 3-(N-methyl-N,N-diethylammonium)propyl methacrylate chloride, 3-(N-methyl-N,N-dipropyl-ammonium)propyl acrylate chloride, 3-(N-methyl-N,N-dipropylammonium)propyl-methacrylate chloride, 3-(N-benzyl-N,N-dimethylammonium)propyl acrylate chloride, 3-(N-benzyl-N,N-dimethylammonium)propyl methacrylate chloride, 3-(N-benzyl-N,N-diethylammonium)propyl acrylate chloride, 3-(N-benzyl-N,N-diethyl ammonium)propyl methacrylate chloride, 3-(N-benzyl-N,N-dipropylammonium)propyl acrylate chloride, and 3-(N-benzyl-N,N-dipropylammonium)propyl methacrylate chloride. Instead of the specified chlorides it is of course also possible to use the corresponding bromides and sulfates.

Preference is given to using 2-(N,N,N-trimethylammonium)ethyl acrylate chloride, 2-(N,N,N-trimethylammonium)ethyl methacrylate chloride, 2-(N-benzyl-N,N-dimethylammonium)ethyl acrylate chloride, and 2-(N-benzyl-N,N-dimethylammonium)ethyl methacrylate chloride.

It is also possible to use any suitable mixtures of the abovementioned ethylenically unsaturated monomers.

It is important that, in the presence of dispersed solid particles having an electrophoretic mobility with a negative sign, a portion or all of the at least one anionic dispersant can be replaced by the equivalent amount of at least one monomer A, and, in the presence of dispersed solid particles having an electrophoretic mobility with a positive sign, a portion or all of the at least one cationic dispersant can be replaced by the equivalent amount of at least one monomer B.

Initiators suitable for use as the at least one free-radical polymerization initiator for the free-radical aqueous emulsion polymerization of the invention include all those capable of triggering a free-radical aqueous emulsion polymerization in the presence of the at least one finely divided inorganic solid. The initiators can in principle be peroxides and also azo compounds. Redox initiator systems are also suitable, of course. Peroxides used can in principle be inorganic peroxides, such as hydrogen peroxide or peroxodisulfates, such as the mono- or di-alkali metal salts or ammonium salts of peroxodisulfuric acid, such as, for example, its mono- and di-sodium, -potassium or ammonium salts, or organic peroxides, such as alkyl hydroperoxides, examples being tert-butyl, p-menthyl or cumyl hydroperoxide, and also dialkyl or diaryl peroxides, such as di-tert-butyl peroxide or dicumyl peroxide. As an azo. compound, use is made substantially of 2,2′-azobis(isobutyronitrile), 2,2′-azobis(2,4-dimethylvaleronitrile) and 2,2′-azobis(amidinopropyl) dihydrochloride (AIBA, corresponding to V-50 from Wako Chemicals). Suitable oxidizing agents for redox initiator systems are essentially the abovementioned peroxides. As corresponding reducing agents it is possible to use compounds of sulfur with a low oxidation state, such as alkali metal sulfites, examples being potassium and/or sodium sulfite, alkali metal hydrogen sulfites, examples being potassium and/or sodium hydrogen sulfite, alkali metal metabisulfites, examples being potassium and/or sodium metabisulfite, formaldehyde-sulfoxylates, examples being potassium and/or sodium formaldehyde-sulfoxylate, alkali metal salts, especially potassium and/or sodium salts, of aliphatic sulfinic acids, and alkali metal hydrogen sulfides, such as potassium and/or sodium hydrogen sulfide, for example, salts of polyvalent metals, such as iron(II) sulfate, iron(II) ammonium sulfate, iron(II) phosphate, enediols, such as dihydroxymaleic acid, benzoin and/or ascorbic acid, and reducing saccharides, such as sorbose, glucose, fructose and/or dihydroxyacetone. In general the amount of free-radical polymerization initiator used, based on the total amount of the monomer mixture, is from 0.1 to 5% by weight.

In accordance with the invention, all of the at least one free-radical polymerization initiator can be introduced in the initial charge together with the at least one finely divided inorganic solid in the reaction medium. It is, however, also possible to include, where appropriate, only some of the at least free-radical polymerization initiator in the initial charge in the aqueous dispersion of solids and then to add all or, where appropriate, the remainder continuously or in batches at the rate at which it is consumed in the course of the free-radical emulsion polymerization of the invention.

Preferred for the process is that first the abovementioned dispersants are added to the aqueous dispersion of solid particles, followed by from 0.01 to 30% by weight, often from 0.5 to 20% by weight, and frequently from 1 to 10% by weight of the total amount of the at least one monomer, discontinuously, in one portion, which is then polymerized up to a conversion of at least 90%, preferably ≧95%. Subsequently the remainder of the at least one ethylenically unsaturated monomer is added continuously or in batches under polymerization conditions and at the rate at which it is consumed. The monomers can be added as they are or else in the form of an aqueous monomer emulsion.

Suitable reaction temperatures for the free-radical aqueous emulsion polymerization in the presence of the at least one finely divided inorganic solid embrace the entire range from 0 to 170° C. In general, the temperatures employed are from 50 to 120° C, frequently from 60 to 110° C., and often ≧70 to 100° C. The free-radical aqueous emulsion polymerization can be conducted at a pressure less than, equal to or greater than 1 bar (absolute), so that the polymerization temperature may exceed 100° C. and may be up to 170° C. Highly volatile monomers such as ethylene, butadiene or vinyl chloride are preferably polymerized under superatmospheric pressure. In that case the pressure can adopt values of 1.2, 1.5, 2, 5, 10, 15 bar or even higher. Where emulsion polymerizations are conducted under subatmospheric pressure, the pressures set are 950 mbar, frequently 900 mbar and often 850 mbar (absolute). The free-radical aqueous emulsion polymerization of the invention is advantageously conducted at 1 bar (absolute) under an inert gas atmosphere, such as under nitrogen or argon, for example.

The aqueous reaction medium may in principle also include water-soluble organic solvents, such as methanol, ethanol, isopropanol, butanols, pentanols, and also acetone, etc., for example. With preference, however, the process of the invention is conducted in the absence of such solvents.

In addition to the abovementioned components, it is also possible as an option to make use in the process of free-radical chain transfer compounds, in order to control and/or reduce the molecular weight of the addition polymers obtainable by the polymerization. Suitable compounds include, essentially, aliphatic and/or araliphatic halogen compounds, such as n-butyl chloride, n-butyl bromide, n-butyl iodide, methylene chloride, ethylene dichloride, chloroform, bromoform, bromotrichloromethane, dibromodichloromethane, carbon tetrachloride, carbon tetrabromide, benzyl chloride, benzyl bromide, organic thio compounds, such as primary, secondary or tertiary aliphatic thiols, such as, for example, ethanethiol, n-propanethiol, 2-propanethiol, n-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and its isomeric compounds, n-octanethiol and its isomeric compounds n-nonanethiol and its isomeric compounds, n-decanethiol and its isomeric compounds, n-undecanethiol and its isomeric compounds, n-dodecanethiol and its isomeric compounds, n-tridecanethiol and its isomeric compounds, substituted thiols, such as 2-hydroxyethanethiol, aromatic thiols, such as benzenethiol, ortho-, meta-, or para-methylbenzenethiol, and all further sulfur compounds described in Polymer handbook 3^{rd} edition, 1989, J. Brandrup and E. H. Immergut, John Weley & Sons, Abschnitt II, pages 133 to 141, and also aliphatic and/or aromatic aldehydes, such as acetaldehyde, propionaldehyde and/or benzaldehyde, unsaturated fatty acids, such as oleic acid, dienes with nonconjugated double bonds, such as divinyl-methane or vinylcyclohexane, or hydrocarbons having readily abstractable hydrogen atoms, such as toluene, for example. It is, however, also possible to use mixtures of mutually undisruptive, free-radical chain transfer compounds mentioned above.

The total amount of the free-radical chain transfer compounds used optionally in the process of the invention, based on the total amount of the monomers to be polymerized, is generally ≦5% by weight, often ≦3% by weight, and frequently ≦1% by weight.

It is favorable if some or all of the optionally employed free-radical chain transfer compound is added to the reaction medium before the free-radical polymerization is initiated. It is additionally possible for some or all of the free-radical chain transfer compound to be supplied to the reaction medium, advantageously, together with the at least one ethylenically unsaturated monomer during the polymerization.

The process can also be implemented by charging a reaction vessel with a stable aqueous dispersion of the at least one finely divided inorganic solid, containing either some or all of the required water, of the at least one anionic, cationic and nonionic dispersant, of the at least one polymerization initiator, and from 0.01 to 30% by weight of the total amount of the mixture of the ethylenically unsaturated monomers, and also of any further customary auxiliaries and additives used, and heating the contents of the reaction vessel to reaction temperature. After the mixture of ethylenically unsaturated monomers has undergone polymerization to a conversion of at least 90%, at this temperature any remaining amounts of the water, of the at least one anionic, cationic and nonionic dispersant, of the at least one ethylenically unsaturated monomer, and also of any further customary auxiliaries and additives are added, continuously or in batches, after which the reaction mixture is held further at reaction temperature where appropriate.

The aqueous dispersions of composite particles that are obtainable in this way normally have a solids content of from 1 to 70% by weight, frequently from 5 to 65% by weight, and often from 10 to 60% by weight.

The composite particles generally possess diameters of ≦1000 nm, frequently ≦500 nm and often ≦250 nm. These particle diameters as well are determined by the method of the analytical ultracentrifuge. The figures stated correspond to what are termed the d₅₀ values.

The composite particles obtainable by the process described can have different structures. The composite particles may comprise one or more of the finely divided solid particles. The finely divided solid particles may be completely enveloped by the polymer matrix. Alternatively it is possible for some of the finely divided solid particles to be enveloped by the polymer matrix, while others are arranged on the surface of the polymer matrix. It is of course also possible for a majority of the finely divided solid particles to be bound on the surface of the polymer matrix. It should be noted that in certain cases, depending on the solids concentration of the dispersed composite particles, there may also be partial agglomeration of the composite particles at a low level.

The monomer residues remaining in the aqueous dispersion of the composite particles after the end of the main polymerization reaction can of course be removed by steam stripping and/or inert gas stripping and/or by chemical deodorization, as described for example in documents DE-A 4 419 518, EP-A 767 180 or DE-A 3 834 734, without adversely affecting the properties of the aqueous dispersion of composite particles.

From the aqueous composite-particle dispersions obtainable by way of the process described it is easily possible to produce addition-polymer films comprising inorganic solid particles. These addition-polymer films, as compared with the addition-polymer films which do not contain inorganic solid particles, are generally of increased mechanical strength, reduced blushing, improved adhesion to mineral surfaces, enhanced resistance to organic solvents, and increased scratch resistance, blocking resistance, and thermal stability. A lower polymer film sensitivity, in particular, and also good flame retardant properties with respect to organic solvents and water, are exhibited by the films of the aqueous composite-particle dispersions, since monomers containing siloxane groups have been copolymerized into the polymers.

The abovementioned properties render the aqueous dispersions used in accordance with the invention particularly advantageous in the priming of mineral substrates, especially grasslike substrates.

In accordance with the second embodiment of the invention it is possible first to prepare a polymer dispersion without using the inorganic solids and then to blend the inorganic solids, in dispersely distributed, finely divided form, with the aqueous polymer dispersion in the presence of at least one dispersant. In this case the above remarks apply analogously to the preparation of the aqueous polymer dispersions and to the selection of the inorganic solids. It has been found in accordance with the invention that for priming glasslike substrates it is also possible with advantage to use blends of the addition polymers in already-polymerized form with the finely divided inorganic solid. This is especially the case with glasslike silicatic surfaces/substrates. Examples of suitable substrates are glazed tiles or plates or panes of glass.

The invention is illustrated by the following examples.

### EXAMPLES

For the examples below the finely divided inorganic solid used was silica, represented by the commercially available silica sol Nyacol® 2040 (20 m) from Akzo-Nobel. The silica content of the aqueous dispersion of solid particles was 40% by weight and its pH was 10. The figure indicated in round brackets corresponds to the diameter of the inorganic solid particles according to manufacturer data.

The dispersion of solids used in the examples met all of the requirements imposed on it: that is, with an initial solids concentration of ≧1% by weight, based on the aqueous dispersion of the solids, one hour after its preparation, without stirring or shaking, it still contained more than 90% by weight of the originally dispersed solid in dispersed form; the dispersed solid particles had a diameter ≦100 nm; and, moreover, in an aqueous standard potassium chloride solution, at a pH corresponding to the pH of the aqueous dispersion medium before the addition of the dispersants was commenced, the dispersed inorganic solid particles exhibited a nonzero electrophoretic mobility.

### 1st Example

In a 2 1 four-necked flask equipped with a reflux condenser, a thermometer, a mechanical stirrer, and a metering apparatus, at 20 to 25° C. (room temperature) and 1 bar (absolute) under a nitrogen atmosphere, and with stirring (200 revolutions per minute), 416.6 g of Nyacol® 2040 and, subsequently, a mixture of 2.5 g of methacrylic acid and 12 g of a 10% strength by weight aqueous solution of sodium hydroxide were added over the course of 5 minutes. The stirred reaction mixture was subsequently admixed over 15 minutes with 10.4 g of a 20% strength by weight aqueous solution of the nonionic surfactant Lutensol® AT18 (trademark of BASF AG, C₁₆C₁₈ fatty alcohol ethoxylate having 18 ethylene oxide units). Metered into the reaction mixture subsequently over 60 minutes was 0.83 g of N-cetyl-N,N,N-trimethylammonium bromide (CTAB), in solution in 200 g of deionized water. The reaction mixture was thereafter heated to a reaction temperature of 76° C.

Prepared in parallel were, as feed stream 1, a monomer mixture consisting of 123.5 g of methyl methacrylate (MMA), 126 g of n-butyl acrylate (n-BA) and 0.5 g of methacryloyloxypropyltrimethoxysilane (MEMO) and, as feedstream 2, an initiator solution consisting of 3.8 g of sodium peroxodisulfate, 11.5 g of a 10% strength by weight aqueous solution of sodium oxide, and 100 g of deionized water.

Subsequently 21.1 g of feedstream 1 and 57.1 g of feedstream 2 were added to the reaction mixture which was stirred at reaction temperature, over the course of 5 minutes using two separate feedlines. After that the reaction mixture was stirred at reaction temperature for 1 hour. Subsequently the reaction mixture was admixed with 0.92 g of a 45% strength by weight aqueous solution of Dowfax® 2A1 and the reaction temperature was raised to 80° C. Then, beginning simultaneously, the remainders of feedstream 1 and feedstream 2 were metered continuously into the reaction mixture over the course of 2 hours. After that the reaction mixture was stirred at reaction temperature for 1 hour more and subsequently was cooled to room temperature.

The transparent aqueous composite-particle dispersion obtained in this way had a solids content of 40.1% by weight, based on the total weight of the aqueous composite-particle dispersion.

The solids content was determined in general by drying approximately 1 g of the composite-particle dispersion in an open aluminum crucible having an internal diameter of about 3 cm in a drying oven at 150° C. until constant weight was obtained. For the determination of the solids content two separate measurements were carried out in each case and the corresponding average was formed.

The d₅₀ particle diameter was determined using an analytical ultracentrifuge to 65 nm (in this respect cf. S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight-Cell-AUC-Multiplexer: High Resolution Particle Size Distribution and Density Gradient Techniques, W. Mächtle, pages 147 to 175). By means of the analytical centrifuge it was also possible to show that the composite particles obtained had a homogeneous density of 1.33 g/cm³. No free silica particles were detectable.

Determining the sign of the electro phoretic mobility in the case of the finely divided inorganic solid used was done using the Zetasizer 3000 from Malvern Instruments Ltd., Great Britain. For this purpose the dispersion of finely divided inorganic solid was diluted with pH-neutral 10 mM potassium chloride solution (standard potassium chloride solution) until its solid-particle concentration was 60 mg per liter. The pH was adjusted to 10 using dilute sodium hydroxide solution. The electrophoretic mobility of the silica particles in Nyacol® 2040 had a negative sign.

### Comparative Example 1

Instead of the aqueous dispersions according to example 1 the commercial acrylate dispersion Acronal® S 559 was used.

### Comparative Example 2

Instead of the aqueous dispersion according to example 1 a commercial acrylate dispersion Acronal® S 533 was used.

The aqueous dispersions of example 1, comparative example 1, and comparative example 2 were applied to glass plates and subjected to a crosshatch test and a blushing test. The test procedures and the results obtained are set out below.

Crosshatch Test

Instruments: Erichsen film drawing frame, crosshatch tester

Substrate: glass plate 480×70 mm

Application: 100 μm wet

Drying: 24 h under SC (standard conditions, 23° C. and 50% relative humidity).

Procedure: The test dispersion is applied using a doctor blade to a glass plate which is fat-free/cleaned beforehand. The dry film thickness ought to be 50 μm. The film is dried under standard conditions for 24 h and then crosshatching is applied. The sample is then immersed vertically in a water bath for 5/10 minutes, after which moisture is carefully damped from the film. An adhesive strip is adhered to the cut lattice and smoothed down, and then the adhesive strip is removed from the specimen at a uniform speed and the resulting damage is assessed.

Assessment: 0=No flaking (the cut edges are completely smooth)

1=The flaked area is approximately 5% of the segments.

2=The flaked area is between 5% and 15% of the segments.

3=The flaked area is between 15 and 35% of the segments.

4=The flaked area is between 35 and 65% of the segments.

5=The flaked area is more than 65% of the segments.

Blushing

Instruments: Erichsen film drawing frame

Substrate: Glass plate 480×70 mm

Application: 100 μm wet

Drying: 24 h under SC

Procedure: The test dispersion is applied using a doctor blade to a glass plate which is fat-free/cleaned beforehand. The dry film thickness ought to be 50 μm. The film is dried under standard conditions for 24 h, then the sample is half-immersed vertically in a waterbath and after 120 minutes the blushing is assessed.

Assessment: 0=No clouding

1=Very slight clouding

2=Stronger clouding

3=Severe clouding

4=Very severe clouding

Results of Primer Testing

TABLE 1

| Test method | Units | C2 | C1 | Example 1 |
|---|---|---|---|---|
| pH | — | 7-8 | 6-7.5 | 9.3 |
| SC | % | 52 | 50 | 40.1 |
| Crosshatch | 0-5 | too soft | 5 | 0 |
| Blushing (120 min) | 0-4 | 4 | 4 | 0 |

As revealed by the results of Table 1, the aqueous dispersion of example 1 exhibits a very advantageous behavior in the crosshatched test and in respect of blushing.

### Example 2

Aqueous polymer dispersions were prepared first of all, then blended with 30% silica sol. For comparison the unblended polymer dispersions were subjected to a crosshatch test.

Preparation was carried out with the monomers indicated below (in parts by weight). Also indicated are the solids content and the pH.

Primer Dispersions

| Sample: | Monomers: | SC: | pH: |
|---|---|---|---|
| C2A | 57.0 n-BA | 52 | 8.2 |
| | 42.0 S | | |
| | 1.00 AA | | |
| 2A | 57.0 n-BA | 51.4 | 7.8 |
| | 41.5 S | | |
| | 0.5 MEMO | | |
| | 1.0 AA | | |
| C2B | 55.0 EHA | 51.9 | 7.4 |
| | 44.0 S | | |
| | 1.00 AA | | |
| 2B | 55.0 EHA | 51.5 | 7.5 |
| | 43.0 S | | |
| | 1.00 AA | | |
| | 1.0 MEMO. | | |

MEMO: methacryloyloxypropyltrimethoxysilane

SC: solids content

NaPS: sodium peroxodisulfate

EHA: ethylhexyl acrylate

n-BA: n-butylacrylate

AA: acrylic acid

S: styrene.

A polymerization reactor is charged under nitrogen with 270 g of water and 10.6 g of a 33% strength by weight aqueous seed latex (polystyrene). This initial charge is heated to 85° C. and, with the temperature maintained, 10% of feedstream 2 is added to the initial charge.

After 5 minutes, beginning simultaneously and at constant rate, feedstream 1 is added over 180 minutes and the remainder of feedstream 2 over 210 minutes. After the end of feedstreams 1 and 2 the mixture is cooled to 65° C. and, in order to reduce the residual monomer content, feedstreams 3 and 4 are metered in over 90 minutes, beginning simultaneously. The dispersion is cooled to room temperature and 26.6 g of a 10% strength by weight sodium hydroxide solution are added.

Feedstream 1 (emulsion feed):

Total amount of monomers: 700 g

Nature of the monomers: see table (p. 33, line 10 et seq)

273.7 g of water

38.9 g of emulsifier Dowfax 2A1 (45% strength by weight aqueous solution of the sodium salt of a diphenyl ether derivatized with a C12-C14 alkyl radical and with two SO₃K radicals)

5.8 g of emulsifier Disponil FES 77 (33% strength by weight aqueous solution of the sodium salt of the sulfuric monoester of an ethoxylated C12 alkanol (degree of ethoxylation at approximately 30))

Feedstream 2 (initiator feed):

30 g water

1.4 g sodium peroxodisulfate

Feedstream 3:

21 g tert-butyl hydroperoxide (10% strength by weight in water)

Feedstream 4:

28 g of a 13% strength by weight aqueous solution of acetone-bisulfite adduct

The various experimental dispersions were then blended each with 30% of silica sol. The results for crosshatch and blushing are summarized in the table below.

Test Results of the Experimental Dispersions

blended with in each case 30% silica sol Nyacol® 2040 (solids/solids) from Akzo Nobel Chemicals GmbH, Düren (particle diameter˜15 nm)

TABLE 2

| | C2A | 2A | C2B | 2B |
|---|---|---|---|---|
| | 30% Nyacol | 30% Nyacol | 30% Nyacol | 30% Nyacol |
| Test method | 2040 | 2040 | 2040 | 2040 |
| Crosshatch | 5 | 3 | 5 | 1 |
| Blushing | 2 | 1 | 2 | 1 |

The unblended dispersions C2A, 2A, C2B and 2B achieve a rating of 5 in the crosshatch testing.

As the table reveals, the blends used in accordance with the invention exhibit advantageous values for blushing and in particular for the crosshatch. They are markedly superior to the comparative systems prepared without the use of the alkoxysiloxane monomers.

1. The process for priming mineral substrates involving the step of applying aqueous dispersions of composite particles composed of addition polymer and finely divided inorganic solid and obtainable by free-radical emulsion polymerization of a mixture of ethylenically unsaturated monomers including at least one ethylenically unsaturated alkoxysilane monomer in an aqueous medium in the presence of a dispersely distributed, finely divided inorganic solid and at least one dispersant to mineral substrates.

2. The process as claimed in claim 1, wherein the mineral substrates are glasslike substrates.

3. The process for priming mineral substrates involving the step of applying aqueous dispersions obtainable by blending an addition polymer obtainable by free-radical emulsion polymerization of a mixture of ethylenically unsaturated monomers including at least one ethylenically unsaturated alkoxy silane monomer in an aqueous medium with a dispersely distributed, finely divided inorganic solid in the presence of at least one dispersant to glasslike substrates.

4. The process as claimed in claim 1, wherein the ethylenically unsaturated alkoxysilane monomers are selected from trialkoxysilanes containing vinyl, acryloyloxy or methacryloyloxy groups as ethylenically unsaturated groups.

5. The process as claimed in claim 1, wherein to prepare the aqueous dispersion polymerization is performed in the presence of at least one anionic, cationic, and nonionic dispersant by the method of free-radical aqueous emulsion polymerization, where
a) a stable aqueous dispersion of the at least one inorganic solid is used which is characterized in that at an initial solids concentration of ≧1% by weight, based on the aqueous dispersion of the at least one inorganic solid, one hour after its preparation it still contains more than 90% by weight of the originally dispersed solid in dispersed form and its dispersed solid particles have a diameter<100 nm,
b) the dispersed solid particles of the at least one inorganic solid in an aqueous standard potassium chloride solution at a pH corresponding to the pH of the aqueous reaction medium before addition of the dispersants is commenced exhibit a nonzero electrophoretic mobility,
c) before commencement of the addition of the mixture of the ethylenically unsaturated monomers, at least one anionic, cationic, and nonionic dispersant is added to the aqueous dispersion of solid particles,
d) thereafter from 0.01 to 30% by weight of the total amount of the mixture of the monomers is added to the aqueous dispersion of solid particles and polymerization is performed up to a conversion of at least 90%, and
e) subsequently the remainder of the mixture of monomers is added under polymerization conditions at the rate at which it is consumed.

6. The process as claimed in claim 5, wherein for the preparation of the aqueous dispersion, based on 100 parts by weight of the mixture of the ethylenically unsaturated monomers, from 1 to 1000 parts by weight of the at least one finely divided inorganic solid are used and wherein, when the dispersed solid particles
a) have an electrophoretic mobility with a negative sign, from 0.01 to 10 parts by weight of at least one cationic dispersant, from 0.01 to 100 parts by weight of at least one nonionic dispersant, and at least one anionic dispersant are used, the amount thereof being such that the equivalent ratio of anionic to cationic dispersant is greater than 1, or
b) have an electrophoretic mobility with a positive sign, from 0.01 to 10 parts by weight of at least one anionic dispersant, from 0.01 to 100 parts by weight of at least one nonionic dispersant, and at least one cationic dispersant are used, the amount thereof being such that the equivalent ratio of cationic to anionic dispersant is greater than 1.

7. The process as claimed in claim 6, wherein
a) where dispersed solid particles having an electrophoretic mobility with a negative sign are present, a portion or all of the at least one anionic dispersant is replaced by the equivalent amount of at least one monomer A containing at least one acid group and/or its corresponding anion, and
b) where dispersed solid particles having an electrophoretic mobility with a positive sign are present, a portion or all of the at least one cationic dispersant is replaced by the equivalent amount of at least one monomer B containing at least one amino, amido, ureido or N-heterocyclic group and/or ammonium derivatives of such a group which are alkylated or protonated on the nitrogen.

8. The process as claimed in claim 5, wherein the at least one nonionic dispersant is added before the at least one cationic and anionic dispersant.

9. The process as claimed in claim 1, wherein the at least one inorganic solid is selected from the group encompassing silica, alumina, hydroxyalumina, calcium carbonate, magnesium carbonate, calcium orthophosphate, magnesium orthophosphate, iron(II) oxide, iron(III) oxide, iron(II/III) oxide, tin(IV) oxide, cerium(IV) oxide, yttrium(III) oxide, titanium dioxide, hydroxylapatite, zinc oxide and zinc sulfide.

10. The process as claimed in claim 1, wherein the at least one inorganic solid is a silica sol having an electrophoretic mobility with a negative sign.
